(19) United States
(12) Patent Application Publication
(10) Pub. No.: US 2026/0351628 A1
(43) Pub. Date: Nov. 5, 2026

(54) METHOD FOR PREPARING METAL BIPOLAR PLATE OF FUEL CELL, AND METAL BIPOLAR PLATE MULTI-STEP FORMING PRODUCTION LINE

(71) Applicant: TONGJI UNIVERSITY, Shanghai (CN)

(72) Inventors: Junying Min, Shanghai (CN); Xianglu Zhang, Xiamen (CN); Pingwen Ming, Shanghai (CN); Zeran Hou, Shanghai (CN); Daijun Yang, Shanghai (CN); Cunman Zhang, Shanghai (CN); Xiaolong Ma, Jining (CN); Yuhang Xia, Nanjing (CN)

(21) Appl. No.: 19/709,330

(22) Filed: Jun. 16, 2026

Related U.S. Application Data
(63) Continuation of application No. PCT/CN2025/076182, filed on Feb. 7, 2025.

(30) Foreign Application Priority Data
Apr. 14, 2024 (CN) 202410443842.8

(51) Int. Cl. H01M 8/0206; H01M 8/0247

(52) U.S. Cl. CPC H01M 8/0206; H01M 8/0247

(57) ABSTRACT

Disclosed are a method for preparing a metal bipolar plate of a fuel cell, and a metal bipolar plate multi-step forming production line. The method for preparing a metal bipolar plate of a fuel cell comprises: a first-stage forming process of utilizing the first-stage stamping equipment to perform first-stage stamping pre-forming on the metal substrate to form a pre-formed metal bipolar plate; a transfer and electric treatment process of controlling a transfer and electric treatment device to move the pre-formed metal bipolar plate to an electric treatment station on the transfer and electric treatment device for electric treatment, and taking out an electrically-treated metal bipolar plate after the electric treatment is finished, a second-stage forming process of utilizing a second-stage stamping equipment to perform second-stage stamping forming on the electrically-treated metal bipolar plate to obtain a completely-formed metal bipolar plate.

### CROSS-REFERENCE TO RELATED APPLICATIONS

This application is a continuation of International Application No. PCT/CN2025/076182, filed on Feb. 7, 2025, which claims priority to Chinese Patent Application No. 202410443842.8, filed on Apr. 14, 2024. The disclosures of the aforementioned applications are hereby incorporated by reference in their entireties.

### TECHNICAL FIELD

The present application relates to the field of a fuel cell, particularly to a multi-step forming production line and process for a metal bipolar plate based on an electric treatment modification effect, and in particular to a method for preparing a metal bipolar plate of a fuel cell, and a metal bipolar plate multi-step forming production line.

### BACKGROUND

Hydrogen energy is an important strategic means to promote the green transformation of the world's energy industry. A proton exchange membrane fuel cell is a key technology for hydrogen energy utilization, and high power, long service life and high performance represent the development trends of the fuel cell. As one of the core components of the fuel cell, a bipolar plate features submillimeter-scale microchannel characteristics, and the fineness of its flow channel has a significant impact on the power generation efficiency, reliability, and service life and the like of the fuel cell. Compared with a traditional graphite bipolar plate, a metal bipolar plate has multiple advantages such as small thickness, low cost, excellent mechanical properties, and superior electrical and thermal conductivity and the like, and has become one of the mainstream trends in fuel cell manufacturing technology research and breakthrough.

However, as the fuel cell imposes increasingly higher requirements on the transport efficiency of reaction gas and product water, the bipolar plate is required to feature a finer flow channel structure and a higher channel depth-to-width ratio. The bottleneck in the formability of ultra-thin metal substrates leads to premature cracking during stamping and forming, which restricts the high-performance development of the fuel cell. In recent years, there have been extensive innovations in the forming methods of metal bipolar plates both domestically and internationally. Although novel laboratory-level processes such as electromagnetic high-speed forming and high-temperature forming can effectively improve the forming limit of the metal bipolar plate, they all exhibit problems of low production efficiency and poor compatibility with existing bipolar plate production lines, limiting their application in practical production. Therefore, there is an urgent need to develop a method of manufacturing a high-performance metal bipolar plate for a fuel cell, which is both efficient and simply compatible with existing metal bipolar plate production lines.

Patent document CN112974642A (Electrically-Assisted Forming Device and Process for Fuel Cell Metal Polar Plate) discloses an electrically-assisted forming process for fuel cell metal polar plate, which utilizes Joule heat and electroplastic effect to reduce a forming force of the metal bipolar plate and improve forming accuracy and consistency thereof by applying electric current to the metal bipolar plate still in a die during the stamping and forming process of the metal bipolar plate. However, the electrically-assisted forming process of this invention focuses on improving the manufacturing accuracy of single-step stamping forming of the metal bipolar plate, with no significant improvement in the forming limit of the metal bipolar plate.

Patent document CN111842611A (Device and Method for Forming Titanium Alloy Bipolar Plate based on Multiple Time-Sequenced Pulse Current) proposes an electromagnetic-thermal composite forming method for a titanium alloy bipolar plate, which improves the forming limit of the titanium alloy bipolar plate by utilizing the thermal effect, electroplastic effect, and high strain rate effect of pulsed electromagnetic force through multi-stage time-sequenced pulsed current discharge. However, the electromagnetic forming device included in this technology is complex, requires high cost, and has low production efficiency, making it unsuitable for practical production applications.

Patent document CN116154208B (High-Precision and High-Corrosion-Resistance Titanium Bipolar Plate for Fuel Cell and Preparation Method and Die Assembly Thereof) proposes a thermally-assisted forming process for an ultra-thin titanium bipolar plate of a fuel cell, in which by adding an annealing heat treatment process between the two stamping forming processes, the internal stress of the titanium bipolar plate generated after the first-stage forming is released and work hardening is eliminated, thereby improving the re-deformation performance and increasing the forming limit of the titanium bipolar plate. However, the heat treatment process in this invention takes a long time (2-30 minutes), which affects the production efficiency of the titanium bipolar plate. In addition, the static recovery process of the heat treatment is often accompanied by grain growth, which limits the enhancement effect of this process on the forming limit of the bipolar plate.

### SUMMARY

In view of the shortcomings of the aforementioned existing technologies, the present invention aims to propose a multi-step forming production line and process for a metal bipolar plate based on electric treatment modification, which can significantly improve the forming limit and forming accuracy of the metal bipolar plate, so as to solve the problems of insufficient microchannel depth, channel cracking, poor dimensional accuracy, etc. in the existing metal bipolar plate forming process, without affecting production efficiency.

In order to achieve the above objectives, the present invention provides a method for preparing a metal bipolar plate of a fuel cell and a metal bipolar plate multi-step forming production line based on electric treatment modification. The metal bipolar plate multi-step forming production line sequentially includes a feeding robot (a feeding device), a first-stage stamping equipment, a transfer and electric treatment device, an electric treatment device, a second-stage stamping equipment, and an unloading robot (an unloading device).

Meanwhile, in terms of the aforementioned production line, the present invention proposes a multi-step forming production process for a metal bipolar plate based on electrical treatment modification, comprising:
S1: a material acquisition process for acquiring a titanium substrate or a ferritic stainless steel substrate with a thickness of 0.05 mm or more and 0.2 mm or less;
S2: an electric treatment parameter acquisition process. Electric treatment refers to a material modification process in which direct current is applied to a metal bipolar plate to repair internal defects and thereby activate plasticity of the metal bipolar plate. Compared with traditional in-furnace annealing heat treatment, it is possible to release the internal stress by ultra-short-time electric treatment, to eliminate deformation twinning and dislocation accumulation generated during the pre-deformation of the ultra-thin metal bipolar plate, and significantly promote static recrystallization, thereby improving the re-deformation performance of the pre-deformed metal bipolar plate and increasing the forming limit. The electric treatment device can provide constant voltage direct current or pulse direct current of any waveform, with an output voltage amplitude of 0 -300 V, a duty cycle of 0-100%, and a frequency of 100-4000 Hz.

For bipolar plates of different sizes, the input electric energy required for defects treatment is also different. The temperature rise of the bipolar plate caused by Joule heating effect in electric treatment is easy to measure and can be used as a simple means of determining the level of the input electric energy, to determine threshold values of the electric treatment parameters. The target temperature for electric treatment is in the range of 500-1200 °C, and the power-on time needs to be controlled within the range of 0.5-10 seconds. In actual production, the electric treatment time should first be selected based on the production cycle requirements, and then the electric treatment process parameters such as output voltage, duty cycle, and frequency should be determined based on the target heating temperature;
S3: a feeding process for automatically transferring, by a feeding robot, sheet blanks into a first-stage stamping equipment via vacuum suction cups, and for positioning the sheet blanks in a first-stage forming die;
S4: a first-stage forming process in which a stamping press moves downward and pre-forms the metal sheet blanks by the first-stage forming die to obtain a metal bipolar plate;
S5: a transfer and electric treatment process in which a transfer and electric treatment device picks up the pre-formed metal bipolar plate via a vacuum suction cup and removes the pre-formed metal bipolar plate from the first-stage stamping equipment. Subsequently, the pre-formed metal bipolar plate is moved to the position of an electric treatment fixture integrated on the transfer and electric treatment device, and an upper chuck of the electric treatment fixture moves downward and clamps both ends of the pre-formed metal bipolar plate, and the vacuum suction cup stops working and moves upward. The electric treatment fixture clamps the pre-deformed metal bipolar plate to complete its transfer between the two stages of the stamping equipment. Meanwhile, electrical treatment modification is performed on the pre-deformed metal bipolar plate, ensuring that the metal bipolar plate has finished the electrical treatment modification and cools down to room temperature before arriving at the second-stage stamping equipment. Finally, the vacuum suction cup moves downward to suck up the metal bipolar plate, the electric treatment fixture is released and retracted, and the metal bipolar plate is transferred into the second-stage stamping equipment and is positioned;
S6: a second-stage forming process in which the stamping press moves downward and fully stamps and forms the electrically treated pre-formed metal bipolar plate by means of a second-stage forming die;
S7: a unloading process for transferring, by an unloading robot, the fully formed metal bipolar plate out of the second-stage stamping equipment.

A method for preparing a metal bipolar plate of a fuel cell, comprising:
a feeding process of feeding a metal substrate to a first-stage stamping equipment having a first-stage forming die, wherein thickness of the metal substrate is less than 0.2 mm;
a first-stage forming process of utilizing the first-stage stamping equipment to perform first-stage stamping pre-forming on the metal substrate to form a pre-formed metal bipolar plate;
a transfer and electric treatment process of controlling a transfer and electric treatment device to move the pre-formed metal bipolar plate to an electric treatment station on the transfer and electric treatment device for electric treatment, and taking out an electrically-treated metal bipolar plate after the electric treatment is finished, wherein a clamping area for the electric treatment is greater than 500 mm²; furthermore, the clamping area for the electric treatment is greater than 1500 mm²; still further, the clamping area for the electric treatment is greater than 2000 mm²;
a second-stage forming process of utilizing a second-stage stamping equipment to perform second-stage stamping forming on the electrically-treated metal bipolar plate to obtain a completely-formed metal bipolar plate; and
an unloading process of removing the completely-formed metal bipolar plate from the second-stage stamping equipment.

As a preferred aspect, at least one intermediate-stage forming process is further included between the first-stage forming process and the second-stage forming process to perform stamping and forming on the metal bipolar plate, and the electric treatment process is disposed between every two adjacent forming processes.

As a preferred aspect, the transfer and electric treatment device includes an electric treatment carrying platform and a transfer platform above the electric treatment carrying platform; the electric treatment carrying platform includes electrode units disposed to be opposite; the electrode unit includes an electrode fixture that can be manipulatively pressed to be closed and opened; the transfer platform is mounted above the electric treatment carrying platform through a vertically movable bracket; the transfer platform is disposed on the vertically movable bracket to be manipulated to move up and down; the transfer platform includes a rectangular frame, and a suction cup assembly that is disposed on the rectangular frame to be manipulated to move in a horizontal direction; the suction cup assembly is used to suck up the metal substrate or the metal polar plate;
the suction cup assembly has a first horizontal position (an initial position) and a second horizontal position in the horizontal direction relative to the rectangular frame; the transfer platform has a first height position and a second height position above the first height position on the vertically movable bracket 5.

As a preferred aspect, during the transfer and electric treatment process, the suction cup assembly is controlled to suck up the pre-formed metal bipolar plate at the second horizontal position and the second height position, then the electrode fixture is opened, and the suction cup assembly is controlled to descend to the first height position and move from the second horizontal position to the first horizontal position. The pre-formed metal bipolar plate is then fed between the electrode fixture, and the suction cup assembly is controlled to release the pre-formed metal bipolar plate and the electrode fixture is controlled to press the pre-formed metal plate for electric treatment. Finally, the electrode fixture is opened to further control the suction cup assembly to suck up the electrically treated metal bipolar plate again to move from the first horizontal position to the second horizontal position, and then the electrically treated metal bipolar plate is moved upward to the second height position.

As a preferred aspect, during the feeding process, a robotic arm is controlled to feed the metal substrate to the first-stage stamping equipment, and after the first-stage forming process is completed, the pre-formed metal bipolar plate is removed from the first-stage stamping equipment;
after the transfer and electric treatment process is completed, the electrically treated metal bipolar plate is transferred to the second-stage stamping equipment by the robotic arm;
during the unloading process, the robotic arm is controlled to remove the completely-formed metal bipolar plate from the second-stage stamping equipment.

As a preferred aspect, the method further comprises an electric treatment parameter acquisition process to acquire electric treatment parameters of the pre-formed metal bipolar plate when the maximum temperature reaches 500-1200 °C at the end of the electric treatment time and the power is cut off; the electric treatment time is 0.5-10 seconds.

As a preferred aspect, the temperature of the pre-formed metal bipolar plate under electric treatment conditions is monitored by an infrared thermal imager.

As a preferred aspect, the electric treatment uses constant voltage direct current or pulse direct current; wherein the output voltage amplitude is 0 -300 V, the duty cycle is 0-100%, and the frequency is 100-4000 Hz.

As a preferred aspect, the channel thickness variation of the completely-formed metal bipolar plate is less than 24 μm.

As a preferred aspect, the electric treatment carrying platform is provided with a first electrically driven guide rail, the electrode fixture includes a lower electrode with both ends fixedly connected to the first electrically driven guide rail and an upper electrode with both ends movably connected to the first electrically driven guide rail, and the first electrically driven guide rail is capable of driving the upper electrode to move up and down to open and close the electrode fixture;
the transfer platform includes an electrically driven telescopic guide rail disposed at a lower side of the rectangular frame; the suction cup assembly is connected between two electrically driven telescopic guide rails and is driven to switch between the first horizontal position (the initial position) and the second horizontal position;
the vertically movable bracket 5 includes two second electrically driven guide rails vertically disposed on the electric treatment carrying platform, and the rectangular frame vertically connects the two second electrically driven guide rails and is driven to switch between the first height position and the second height position.

A metal bipolar plate multi-step forming production line for implementing the method for preparing a metal bipolar plate of a fuel cell as described above, comprising: a feeding device, a first-stage stamping equipment, a transfer and electric treatment device, a second-stage stamping equipment and an unloading device; wherein
the feeding device is used to feed a metal substrate to a first-stage stamping equipment having a first-stage forming die;
the first-stage stamping equipment is used to perform first-stage stamping pre-forming on the metal substrate to form a pre-formed metal bipolar plate;
the transfer and electric treatment device is used to move the pre-formed metal bipolar plate to an electric treatment station on the transfer and electric treatment device for electric treatment, and to take out an electrically-treated metal bipolar plate after the electric treatment is finished;
the second-stage stamping equipment is used to perform second-stage stamping forming on the electrically-treated metal bipolar plate to obtain a completely-formed metal bipolar plate; and
the unloading device is used to remove the completely-formed metal bipolar plate from the second-stage stamping equipment.

Compared with the prior art, the present invention has the following advantageous effects:
1. In the method for preparing a metal bipolar plate of a fuel cell, and the metal bipolar plate multi-step forming production line of the present invention, an electric treatment process is added between two stamping processes, the internal stress of the pre-formed metal polar plate can be released within an extremely short processing time, and deformation twinning and dislocation accumulation can be eliminated, thereby ultimately significantly improving the forming limit and forming accuracy of the metal bipolar plate.
2. In the method for preparing a metal bipolar plate of a fuel cell, and the metal bipolar plate multi-step forming production line of the present invention, the electric treatment device is integrated onto the transfer and electric treatment device, so that the pre-formed metal bipolar plate can be transferred to next stamping process while being electrically treated so as to eliminate deformation twinning and dislocation accumulation, without affecting production efficiency.
3. In the method for preparing a metal bipolar plate of a fuel cell, and the metal bipolar plate multi-step forming production line of the present invention, it is proposed that a multi-step forming production line for a metal bipolar plate based on an electric treatment modification effect can be obtained by simple reconstruction based on the existing series stamping automation production line, with low investment cost and wide applicability.

Specific embodiment of the invention is disclosed in detail with reference to the following description and the accompanying drawings, indicating the manner in which the principles of the invention may be employed. It should be understood that the embodiment of the present invention is not thus limited in scope.

The features described and/or shown for one embodiment can be used in one or more other embodiments in the same or similar manner, can be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

In order to more clearly explain the embodiments of the invention or the technical solution in the prior art, drawings that need to be used in the description in embodiments or the prior art will be simply introduced below, obviously the drawings in the following description are merely some examples of the invention, for persons ordinarily skilled in the art, it is also possible to obtain other drawings according to these drawings without making creative efforts.

FIG. 1 shows the temperature distribution and local temperature history during the microchannel electric treatment process of the target bipolar plate in Embodiment 1;

FIG. 2 shows the cross-sectional design parameters of the flow channels for (a) a first-stage forming die and (b) a second-stage forming die in the Embodiment 1;

FIG. 3 shows (a) a titanium bipolar plate formed by traditional room temperature multi-step stamping and (b) a titanium bipolar plate formed by the new method of the present invention in the Embodiment 1;

FIG. 4 shows the flow channel thickness distribution of (a) the titanium bipolar plate formed by traditional room temperature multi-step stamping and (b) the titanium bipolar plate formed by the new method of the present invention in the Embodiment 1;

FIG. 5 is a column chart of total elongation under long-time electric treatment of a sample at 550 °C;

FIGS. 6 and 7 are column charts of the total elongation of the sample subjected to electric treatment for 2 sec, 3 sec, 5 sec and 10 sec respectively at 500 °C (E10.5%), 600 °C (E13.5%) and 700 °C (E16.8%);

FIG. 8 is a column chart of the total elongation of the sample after rapid heating for 2 seconds to different target temperatures;

FIG. 9 is a column chart of the total elongation of the sample subjected to different pre-deformation amounts and heated to different target temperatures;

FIG. 10 is a diagram showing comparison of results of intermediate electric treatment between two forming processes on the sample using a single die;

FIG. 11 is a stereoscopic structural schematic diagram of a transfer and electric treatment device provided by an embodiment of the present invention;

FIG. 12 is another view of FIG. 11;

FIG. 13 is a side view of FIG. 11; and

FIG. 14 is a process view of transfer and electric treatment performed by the transfer and electric treatment device shown in FIG. 11.

### DETAILED DESCRIPTION OF EMBODIMENTS

In order to make those skilled in the art better understand the technical solutions in the present invention, the technical solutions in the embodiments of the present invention will be clearly and completely described in the following with reference to the accompanying drawings in the embodiments of the present application. Obviously, the described embodiments are only a part of the embodiments of the present invention, but not all of them. Based on the embodiments of the present invention, all other embodiments that are obtained by persons skilled in the art without making creative efforts shall fall within the protection scope of the present invention.

It should be noted that when an element is referred to as being “disposed” on another element, it may be directly on another element or there may be another element in the middle. When one element is considered to be “connected” to another element, it may be connected directly to another element or there may be another element in the middle. The terms “vertical,” “horizontal,” “left,” “right” and other similar expressions used herein are used for illustrative purposes only and are not meant to be the only embodiment.

Unless otherwise defined, all technical and scientific terms used herein have the same meanings as that are generally understood by those skilled in the art belonging to the technical field of the present invention. The terms used herein in the description of the invention are for purposes of describing specific embodiments only and are not intended to limit the invention. The terms “and/or” as used herein include any and all combinations of one or more related listed items.

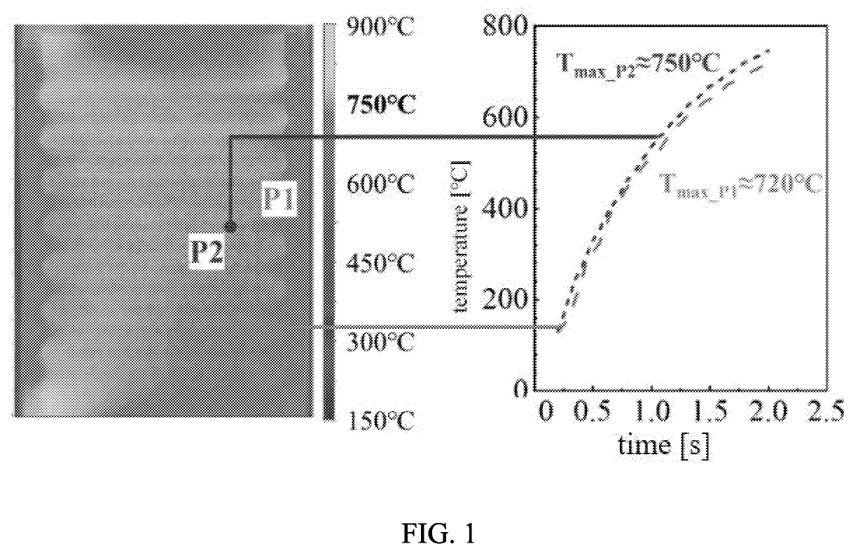

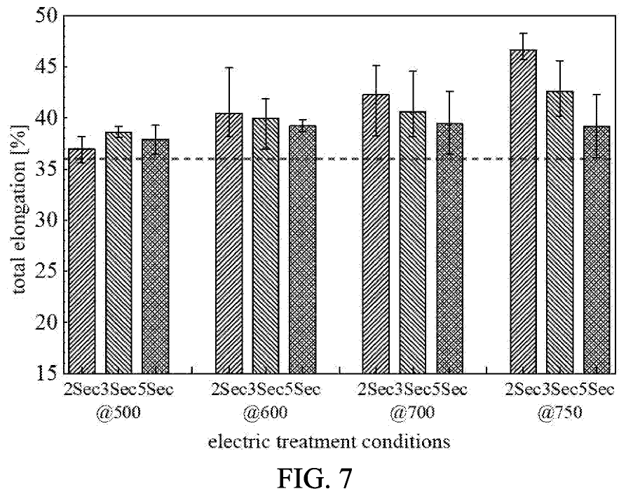

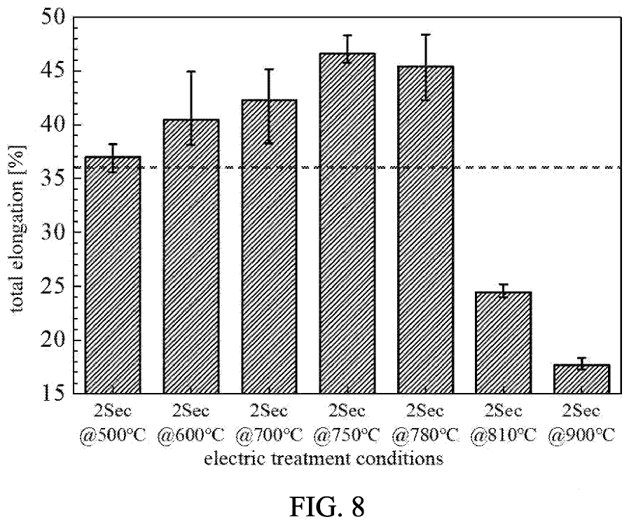

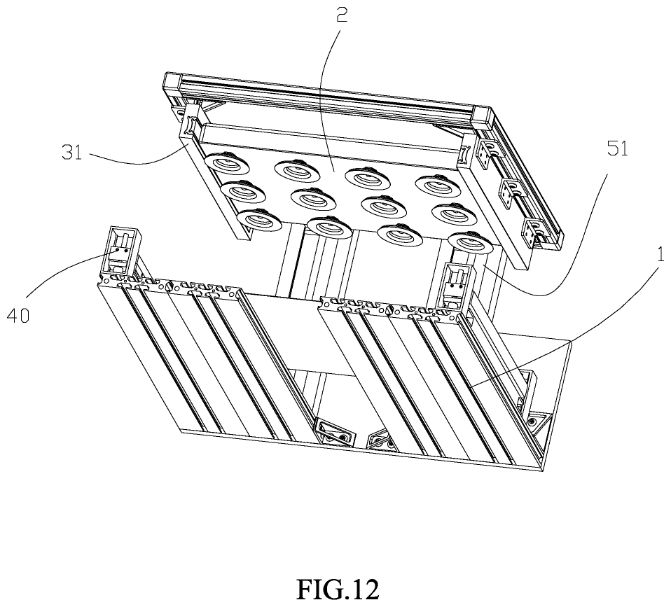

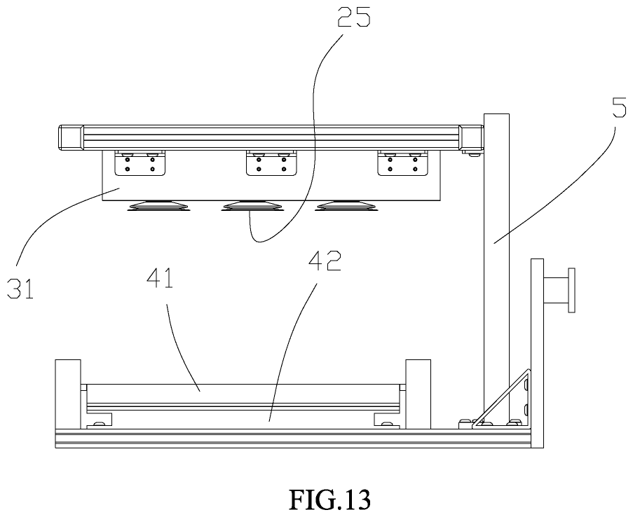

Referring to FIGS. 1 to 14, an embodiment of the present invention provides a method for preparing a metal bipolar plate of a fuel cell, and correspondingly, in order to implement the preparation method, the embodiment further provides a metal bipolar plate multi-step forming production line. The metal bipolar plate multi-step forming production line includes: a feeding device, a first-stage stamping equipment, a transfer and electric treatment device, a second-stage stamping equipment and an unloading device.

The feeding device is used to feed a metal substrate to a first-stage stamping equipment having a first-stage forming die. The feeding device adopts a feeding robot, specifically a robotic arm. The first-stage stamping equipment is used to perform first-stage stamping pre-forming on the metal substrate to form a pre-formed metal bipolar plate. The transfer and electric treatment device is used to move the pre-formed metal bipolar plate to an electric treatment station on the transfer and electric treatment device for electric treatment, and to take out an electrically-treated metal bipolar plate after the electric treatment is finished. The second-stage stamping equipment is used to perform second-stage stamping forming on the electrically-treated metal bipolar plate to obtain a completely-formed metal bipolar plate. The unloading device is used to remove the completely-formed metal bipolar plate from the second-stage stamping equipment. The unloading device adopts an unloading robot, specifically a robotic arm. The feeding robotic arm and the unloading robotic arm are different robotic arms, which are disposed along the process steps of the production line. Naturally, as feasible implementation, the feeding device and the unloading device may adopt the same robotic arm.

The stamping equipments each include a stamping press and a die. The die structure can adopt the die disclosed in the patent document CN116154208A titled “High-Precision and High-Corrosion-Resistance Titanium Bipolar Plate for Fuel Cell and Preparation Method and Die Assembly Thereof”, and the repeated contents will not be repeated. The stamping press adopts a precision press, such as a YKP-630 precision press. The electric treatment device includes a DC power supply, a copper electrode, and an insulating electric wood fixture. The electrode and the insulating fixture are integrated into the transfer and electric treatment device, for grasping and transferring the pre-formed metal bipolar plate.

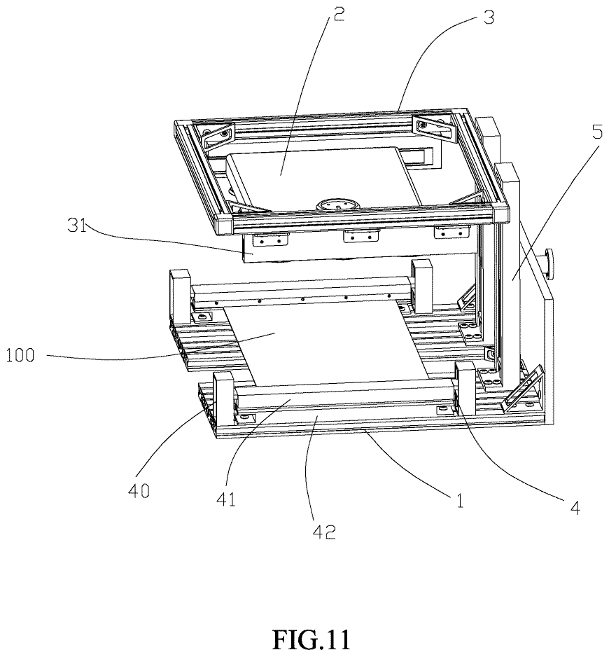

As shown in FIGS. 11 to 14, the embodiment further provides a transfer and electric treatment device. The transfer and electric treatment device includes an electric treatment carrying platform 1 and a transfer platform 3 above the electric treatment carrying platform 1; the electric treatment carrying platform 1 includes electrode units 4 disposed to be opposite; and the electrode unit 4 includes an electrode fixture that can be manipulatively pressed to be closed and opened. The transfer platform 3 is mounted above the electric treatment carrying platform 1 through a vertically movable bracket 5; and the transfer platform 3 is disposed on the vertically movable bracket 5 to be manipulated to move up and down. The transfer platform 3 includes a rectangular frame, and a suction cup assembly 2 that is disposed on the rectangular frame to be manipulated to move in a horizontal direction; and the suction cup assembly 2 is used to suck up the metal substrate or the metal polar plate 100.

The suction cup assembly 2 has a first horizontal position and a second horizontal position in the horizontal direction relative to the rectangular frame; the transfer platform 3 has a first height position and a second height position above the first height position on the vertically movable bracket 5. The first horizontal position below the second height position is the initial position of the suction cup assembly 2.

Specifically, the electric treatment carrying platform 1 is provided with a first electrically driven guide rail 40. The electrode fixture includes a lower electrode 42 with both ends fixedly connected to the first electrically driven guide rail 40 and an upper electrode 41 with both ends movably connected to the first electrically driven guide rail 40, and the first electrically driven guide rail 40 is capable of driving the upper electrode 41 to move up and down to open and close the electrode fixture. The lower electrode 42 and the upper electrode 41 are copper electrodes.

The transfer platform 3 includes an electrically driven telescopic guide rail 31 disposed at a lower side of the rectangular frame. The suction cup assembly 2 is connected between two parallel electrically driven telescopic guide rails 31 and is driven to switch between the first horizontal position and the second horizontal position. The vertically movable bracket 5 includes two second electrically driven guide rails 51 vertically disposed on the electric treatment carrying platform 1, and the rectangular frame vertically connects the two second electrically driven guide rails 51 and is driven to switch between the first height position and the second height position.

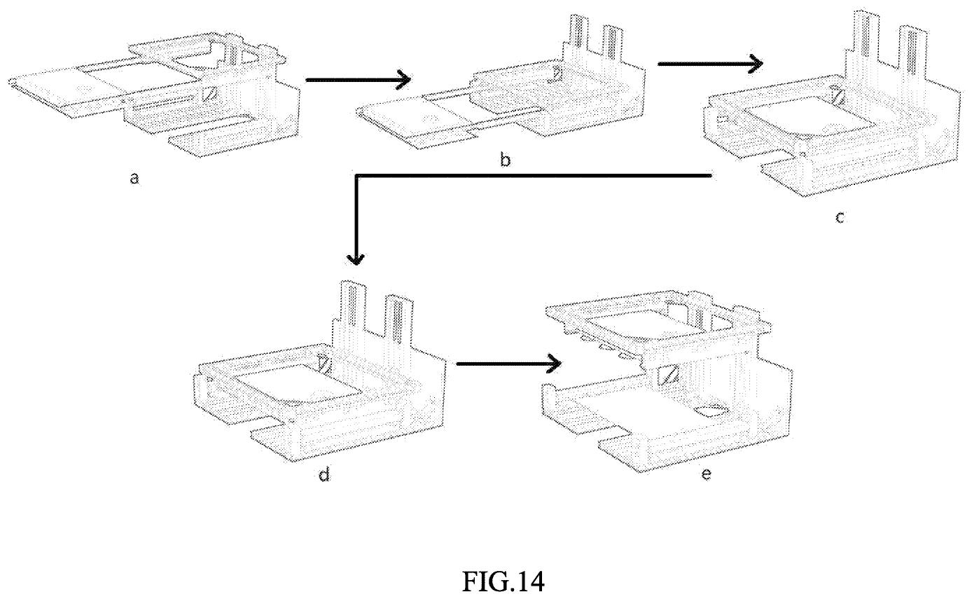

As shown in the figure a of FIG. 14, when the suction cup assembly 2 is located at the second horizontal position and at the second height position, the suction cup assembly 2 is used to suck up or unload the metal substrate or the metal bipolar plate. When the suction cup assembly 2 is located at the second horizontal position, it is used to switch and move between the first height position and the second height position, and the second horizontal position is the horizontal position as shown in the figure b of FIG. 15B. As shown in the figure b of FIG. 14, when the suction cup assembly 2 is located at the second horizontal position and at the first height position, it can be moved to the first horizontal position to feed the metal substrate or the metal bipolar plate between the opened electrode fixture.

In this embodiment, the method for preparing a metal bipolar plate of a fuel cell includes the following process steps:
a feeding process of feeding a metal substrate with a thickness of 0.05 mm or more and 0.2 mm or less to a first-stage stamping equipment having a first-stage forming die;
a first-stage forming process of utilizing the first-stage stamping equipment to perform first-stage stamping pre-forming on the metal substrate to form a pre-formed metal bipolar plate;
a transfer and electric treatment process of controlling a transfer and electric treatment device to move the pre-formed metal bipolar plate to an electric treatment station on the transfer and electric treatment device for electric treatment, and taking out an electrically-treated metal bipolar plate after the electric treatment is finished, wherein a clamping area for the electric treatment is greater than 500 mm²;
a second-stage forming process of utilizing a second-stage stamping equipment to perform second-stage stamping forming on the electrically-treated metal bipolar plate to obtain a completely-formed metal bipolar plate; and
an unloading process of removing the completely-formed metal bipolar plate from the second-stage stamping equipment. The channel thickness variation of the completely-formed metal bipolar plate is less than 24 μm, and the channel depth-to-width ratio is greater than 0.79.

In other embodiments, the method for preparing a metal bipolar plate of a fuel cell is not limited to one intermediate electric treatment between two stamping processes, and can include multiple stamping processes and multiple electric treatment processes. Therefore, at least one intermediate-stage forming process is further included between the first-stage forming process and the second-stage forming process to perform stamping and forming on the metal bipolar plate, and the electric treatment process is disposed between every two adjacent forming processes. Through multiple electric treatments, the metal bipolar plate can ultimately achieve a higher forming limit.

As shown in FIG. 14, during the transfer and electric treatment process, firstly, as shown in the figure a of FIG. 14, the suction cup assembly 2 is controlled to suck up the pre-formed metal bipolar plate at the second horizontal position and the second height position, then as shown in the figures b to c of FIG. 14, the electrode fixture is opened, and the suction cup assembly 2 is controlled to descend to the first height position and move from the second horizontal position to the first horizontal position, and the pre-formed metal bipolar plate is then fed between the electrode fixture, and the suction cup assembly 2 is controlled to release the pre-formed metal bipolar plate and then as shown in the figure d of FIG. 14, the electrode fixture is controlled to press the pre-formed metal plate for electric treatment, to lift the suction cup assembly 2 to the initial position (the second horizontal position at the second height position). Finally, the electrode fixture is opened to further control the suction cup assembly 2 to return to the position shown in the figure d again to suck up the electrically treated metal bipolar plate to move from the first horizontal position to the second horizontal position, and then the electrically treated metal bipolar plate is moved upward to the second height position.

During the feeding process, a robotic arm is controlled to feed the metal substrate to the first-stage stamping equipment, and after the first-stage forming process is completed, the pre-formed metal bipolar plate is removed from the first-stage stamping equipment. After the transfer and electric treatment process is completed, the electrically treated metal bipolar plate is transferred to the second-stage stamping equipment by the robotic arm. During the unloading process, the robotic arm is controlled to remove the completely-formed metal bipolar plate from the second-stage stamping equipment.

The method for preparing a metal bipolar plate of a fuel cell further comprises an electric treatment parameter acquisition process to acquire electric treatment parameters of the pre-formed metal bipolar plate when the maximum temperature reaches 500-1200 °C at the end of the electric treatment time and the power is cut off; the electric treatment time is 0.5-10 seconds. In the electric treatment parameter acquisition process, the temperature of the pre-formed metal bipolar plate under electric treatment conditions is monitored by an infrared thermal imager.

The electric treatment uses constant voltage direct current or pulse direct current; wherein the output voltage amplitude is 0 -300 V, the duty cycle is 0-100%, and the frequency is 100-4000 Hz.

In this embodiment, given that the thickness of the bipolar plate is small (<0.2 mm), but the clamping area for the electric treatment is large (>500mm2 , generally >2000 mm2), the quality of contact between the copper electrode and the metal bipolar plate is high. However, due to the contact between rigid surfaces, surface flatness errors of upper and lower electrodes during machining, an assembly error between the upper and lower electrodes and the electrode fixture, as well as a motion error of the upper electrode during downward movement may all lead to uneven stress distribution on the clamped surface of the bipolar plate when the electrodes are in a closed state. This may cause the following defects in the pre-formed bipolar plate during the electric treatment process: uneven current density caused by local contact resistance difference, or even electrical erosion damage on the contact surfaces; local bending and deformation of the clamping section; and sliding issues arising from the inability to apply a clamping force uniformly and effectively.

To solve such problems, a rubber pad is added on the surface of the upper electrode that faces the lower electrode, thereby improving stress transfer and increasing the actual contact area, achieving more uniform electrical conduction and more reliable clamping. The rubber pad is a rectangular rubber pad, and has a thickness smaller than that of the lower electrode. Among the upper and lower electrodes, the rubber pad covers the lower surface of the upper electrode, and the area of the upper surface of the lower electrode is larger than that of the lower surface of the rubber pad. The end of the metal bipolar plate is clamped between the rubber pad and the upper surface of the lower electrode.

In the method for preparing a metal bipolar plate of a fuel cell, and the metal bipolar plate multi-step forming production line provided by the embodiments of the present invention, an electric treatment process is added between two stamping processes, the internal stress of the pre-formed metal polar plate can be released within an extremely short processing time, and deformation twinning and dislocation accumulation can be eliminated, thereby ultimately being capable of significantly improving the forming limit and forming accuracy of the metal bipolar plate.

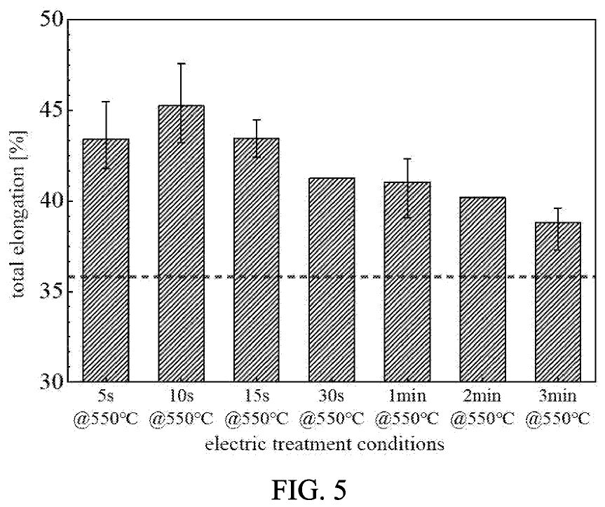

In the embodiment of the present invention, electric treatment of the pre-formed metal bipolar plate, especially a titanium bipolar plate, is a means of adding a material modification process in the forming process from a raw material to a finished part, aiming to improve the machinability of the material (the manufacturability of the part). Furthermore, as to the ductility (elongation) as verified in FIGS. 5 to 11, in the present invention, for the electric treatment of the metal bipolar plate (titanium bipolar plate), it is hoped that in the most ideal situation, defects such as dislocations and twinning are completely eliminated, and recrystallization is completed, and the deformed grains are replaced with new equiaxed grains, so as to maximize the ductility of the material and thereby achieve a higher forming limit of the metal bipolar plate.

FIGS. 5 to 10 are diagrams showing the verification results obtained by the inventor to verify the effect of electric treatment in the forming process of the metal bipolar plate.

FIG. 5 shows the results of multi-step stretching and measuring the total elongation of a titanium substrate with a thickness of 0.1 mm produced by a certain steel plant (i.e., the scenario described in the Embodiment 3 below). Specifically, the titanium substrate is first stretched by 15% along the rolling direction, and then subjected to electric treatment under different electric treatment conditions as shown in FIG. 5 (5 s@550 °C means 5 seconds of electric treatment, and the highest temperature of the sheet metal reaches 550 °C when the power is cut off. The maximum temperature for this group of experiments was uniformly 550 °C, but the duration of the electric treatment varied.), and finally reloaded and stretched until fracture occurs. The total elongation of the titanium substrate after two times of stretching is calculated, which is compared with that of the sample also subjected to two times of stretching without intermediate electric treatment (i.e., the position marked by the dashed line in FIG. 5, and the elongation of this sample is approximately 35.8%). The elongation rates of the sample under the electric treatment conditions are all improved to varying degrees. Elongation rate is an important indicator for evaluating the ductility of a sample. The higher the elongation rate is, the greater the tensile deformation that the material can withstand before fracture is, thereby proving the ability of electric treatment to improve the forming limit of the titanium substrate.

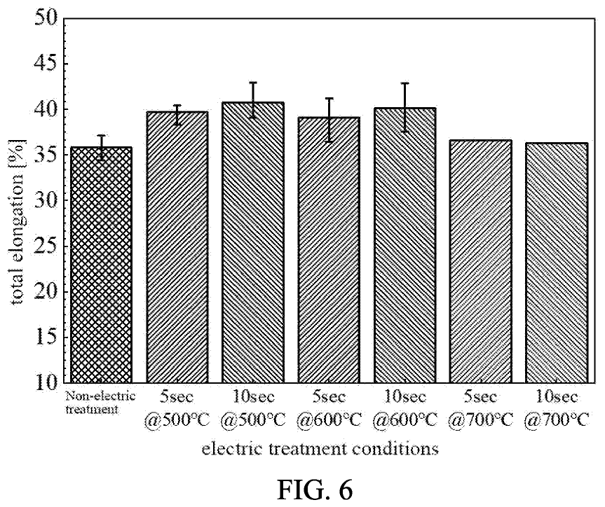

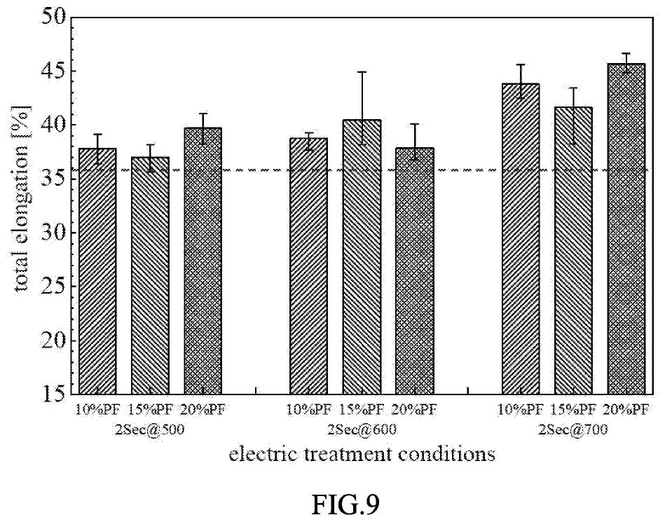

FIGS. 6, 7 and 8 also show the results of similar tensile experiments of the titanium bipolar plate, with only the parameters of the electric treatment changed. It can also be seen that the elongation rates of the sample under different electric treatment conditions have all been improved to varying degrees. FIG. 9 shows comparison of total elongation after varying pre-deformation amounts (originally only 15%, now 10%, 15%, and 20% are put together for comparison), followed by electric treatment at 500 °C, 600 °C and 700 °C for 2 seconds respectively. It can also be seen that electric treatment is equally effective for the sample with different pre-deformation amounts, and the overall trend of the effect is the same.

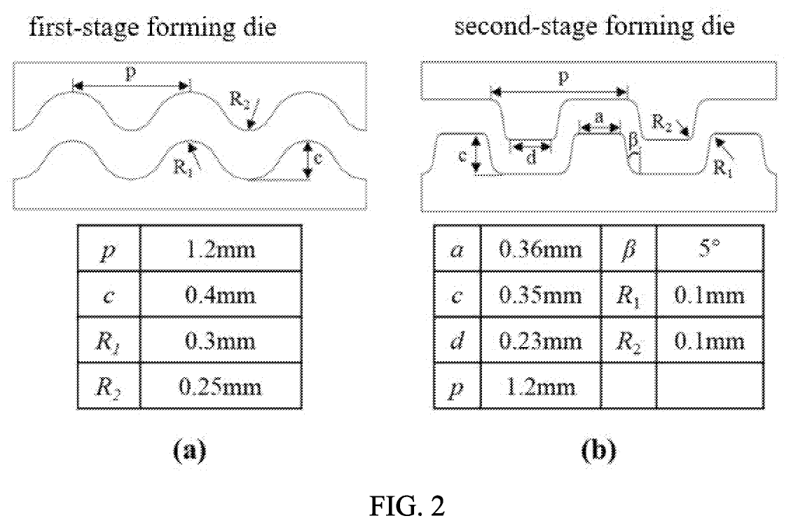

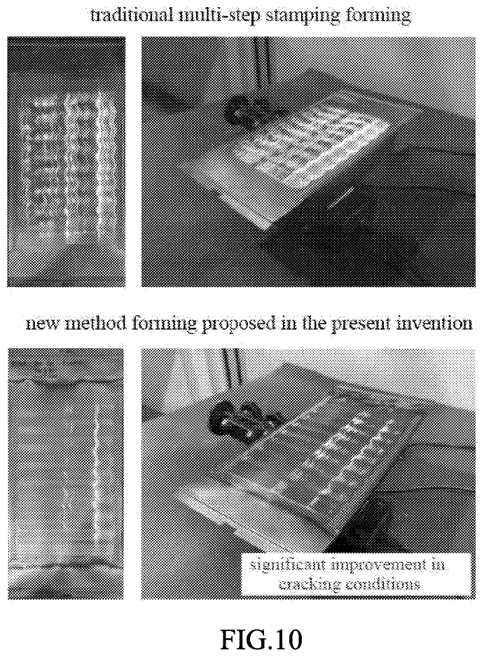

FIG. 10 is a diagram showing the result of comparison between two forming processes performed by controlling the stamping depth directly in the second-stage forming die without using the first-stage forming die in FIG. 2. Compared to the traditional simple multi-step stamping forming (the upper figure in FIG. 10), the improved process (the lower figure in FIG. 10) controls the stamping depth to about 0.25 mm during the first forming process, and at this time, the bipolar plate still does not crack, and afterwards, the bipolar plate is subjected to electric treatment and then put back into the die to be fully stamped to a final depth of 0.35. From the results shown in FIG. 10, it can be seen that pure electric treatment has a significant improvement effect on the forming limit of the sheet metal. It can be seen that the sample treated by the traditional process without electric treatment suffers complete cracking, which further indicates that the sample far exceeds the forming limit. However, the cracking situation of the sample after electric treatment is significantly improved, indicating the effect of electric treatment on improving the local forming limit.

The following will further illustrate the present invention through several specific embodiments, in order to better understand the present invention.

### Embodiment 1

This embodiment provides a new method capable of improving a forming limit and cross-sectional thickness distribution uniformity of a metal bipolar plate, in which the flow channel cycle of a target bipolar plate to be formed is 1.2 mm, the draft angle is 5 °, the fillet radius is 0.1 mm, and the aspect ratio is 0.79. The method comprises specific steps as follows:

### S1: Raw Material Selection

In this embodiment, the sample substrate is selected from a TA1 industrial pure titanium with a thickness of 0.1 mm and a titanium element content higher than 99.5% produced by a certain steel plant. The industrial pure titanium refers to a titanium substrate with an α-phase structure obtained by annealing heat treatment after cold rolling.

### S2: Electric Treatment Parameter Acquisition

In order to acquire electric treatment parameters, a piece of pre-formed titanium bipolar plate is utilized, and the temperature of the pre-formed titanium bipolar plate under electric treatment conditions is monitored using an infrared thermal imager. The electric treatment time is selected to be 2 seconds, and the maximum temperature of the titanium bipolar plate is ensured to reach 750 °C when the power is cut off after 2 seconds of electric treatment, as shown in FIG. 1. For the pre-formed titanium bipolar plate with a width of 100 mm in this embodiment, the obtained output voltage of the power box is 120 V, the duty cycle is 70%, and the pulse frequency is 300 Hz.

### S3: Feeding

A feeding robot is utilized to transfer the ultra-thin titanium substrate obtained in S1 to the first-stage stamping equipment and to position the ultra-thin titanium substrate.

### S4: First-Stage Forming

The first-stage forming die shown in FIG. 2a is utilized to perform the first-stage stamping forming on the sheet blanks after being fed in S3.

### S5: Transfer and Electric Treatment

A vacuum suction cup integrated on the integrated fixture of the transfer and electric treatment device to suck up the pre-deformed titanium bipolar plate obtained in S4 from the first-stage stamping die and move the pre-deformed titanium bipolar plate to the electric treatment station in the integrated fixture. After the pre-deformed titanium bipolar plate is recognized to reach the designated position, the servo motor drives the upper chuck of the electrode to move downward and clamp the titanium bipolar plate. Subsequently, the vacuum pump suspends working and the suction cup moves upwards. The pulse current calibrated in S2 is applied to the pre-deformed titanium bipolar plate, and at the same time, the robotic arm of the transfer and electric treatment device is moved to drive the entire integrated fixture to move towards the second-stage stamping station. After the electric treatment is completed, the suction cup moves downward and the vacuum pump is restarted, the upper chuck moves upward to release the titanium bipolar plate, and the titanium bipolar plate is transferred by the vacuum suction cup to the second-stage stamping equipment and is positioned.

### S6: Second-Stage Forming

The second-stage forming die shown in FIG. 2b is utilized to perform the second-stage stamping forming on the titanium bipolar plate after electric treatment in S5.

### S7: Unloading

The formed titanium bipolar plate is transferred out of the second-stage stamping equipment by the unloading device.

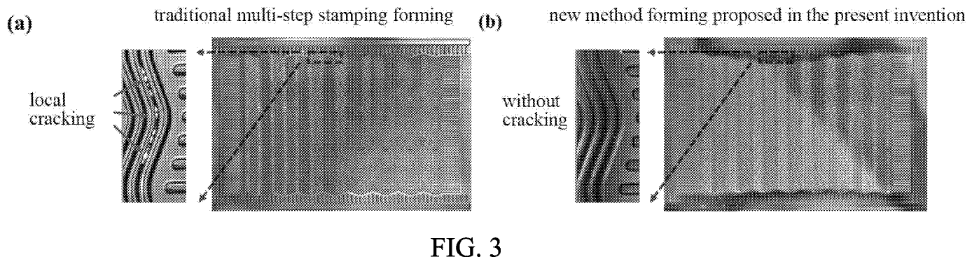

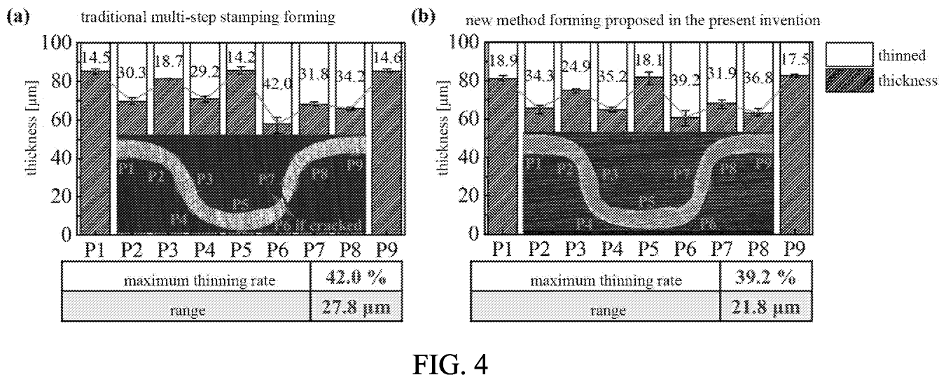

FIG. 3 shows the titanium bipolar plate microchannels formed by the traditional room-temperature multi-step forming process and the novel method proposed in the present disclosure, respectively. Adopting the novel method proposed in the present invention can break through the forming limit of the titanium bipolar plate and obtain the target bipolar plate without cracks. As shown in FIG. 4, the thickness distribution uniformity of the bipolar plate flow channel is evaluated by a range method. That is, 9 feature positions (namely the midpoints of the ridge, the groove, and the sidewall, as well as the maximum thinning position of the fillet) are selected on each channel profile cycle to measure the substrate thickness. It is found that the thickness range of the titanium bipolar plate microchannels manufactured by the traditional multi-step forming process is large (27.8 μm), and the excessive thinning of the weakest corner position (P6) ultimately causes cracking of the flow channel. The method proposed by the present invention can promote uniform deformation of materials during the forming process, thereby improving the uniformity of channel thickness and reducing the channel thickness range to about 21.8 μm.

### Embodiment 2

In this embodiment, TA1 industrial pure titanium with a thickness of 0.1 mm is used, which is the same as that of the Embodiment 1. The flow channel cycle of the target bipolar plate to be formed is 1.8 mm, and the channel depth is 0.38 mm. Titanium bipolar plates without cracks can be manufactured by the traditional multi-step stamping forming, but the accuracy of the flow channel size is poor.

Adopting the new method provided by the present invention, the pre-formed titanium bipolar plate is first subjected to one-time electric treatment. The electric treatment time is selected to be 2 seconds, and the maximum temperature in the flow channel region of the titanium bipolar plate is ensured to reach 730 °C when the power is cut off after 2 seconds of electric treatment. At this time, the calibrated output voltage of the power box is 190 V, the duty cycle is 100%, and the pulse frequency is 4000 Hz. The channel depth of the titanium bipolar plate formed by the new method of the present invention is about 10 μm higher than that of the titanium bipolar plate formed by multi-step cold stamping forming, and the cross section of the formed channel is closer to the design value, proving that the new method of the present invention can also be an effective means to improve the channel size accuracy of the target metal bipolar plate.

### Embodiment 3

In this embodiment, the sample substrate is selected from a TA1 industrial pure titanium with a thickness of 0.1 mm and a titanium element content higher than 99.5% produced by a certain steel plant, aiming to improve the fracture elongation of the titanium bipolar plate.

Adopting the new method provided by the present invention, the titanium bipolar plate is pre-stretched to a 15% elongation rate, and then subjected to 10 seconds of electric treatment to ensure that the maximum temperature reaches 550 °C when the power is cut off after 10 seconds of electric treatment. Finally, the titanium bipolar plate is loaded and stretched again until fracture occurs. The results of the tensile experiments show that the elongation of the titanium bipolar plate is increased by about 23% compared to the tensile conditions at room temperature.

### Embodiment 4

In this embodiment, the sample substrate is selected from 446 ferritic stainless steel with a thickness of 0.1 mm produced by a domestic steel plant. Based on uniaxial tension, the feasibility of extending and applying the new method proposed in this invention to the ultra-thin stainless steel substrate has been explored.

Adopting the new method provided by the present invention, the ferritic stainless steel sheet is pre-stretched to a 15% elongation rate, and then subjected to 2 seconds of electric treatment to ensure that the maximum temperature reaches 1000 °C when the power is cut off after 2 seconds of electric treatment, and finally loaded and stretched again until fracture occurs. The results of the tensile experiments show that the elongation of the ferritic stainless steel is increased by about 32% compared to the tensile conditions at room temperature, proving that the new method of the present invention can improve the formability of the ferritic stainless steel.

Any numerical value referred to herein includes all values of a lower value and an upper value that are incremented by one unit from a lower limit value to an upper limit value, with an interval of at least two units between any lower value and any higher value. For example, if it is stated that the number of components or process variables such as temperature, pressure, time, etc., have a value from 1 to 90, preferably from 20 to 80, more preferably from 30 to 70, the purpose is to illustrate that the equivalents such as 15 to 85, 22 to 68, 43 to 51, 30 to 32 are also explicitly recited in the specification. For values smaller than 1, one unit is suitably considered to be 0.0001, 0.001, 0.01, 0.1. These are merely intended to be explicitly expressed examples, and it may be considered that all possible combinations of numerical values enumerated between the lowest value and the highest value are explicitly set forth in a similar manner in this specification.

Unless otherwise stated, all ranges include end points and all numbers between the end points. The “about” or “approximate” used with the range is suitable for both end points of the range. Thus, “about 20 to 30” is intended to cover “about 20 to about 30,” including at least the indicated end points.

It should be understood that the above description is for purposes of illustration and not for purposes of limitation. Many embodiments and many applications other than the examples provided will be apparent to those skilled in the art from reading the above description. Accordingly, the scope of the present teachings should not be determined with reference to the above description, but should be determined with reference to the appended claims and the full scope of equivalents owned by these claims. The disclosure of all articles and references, including patent applications and publications, is incorporated herein by reference for purposes of completeness. The omission of any aspect of the subject matter disclosed herein in the foregoing claims is not intended to waive the subject matter and the inventor should not be deemed to have considered the subject matter as a part of the disclosed subject matter.

What is claimed is:

1. A method for preparing a metal bipolar plate of a fuel cell, comprising:
a feeding process of feeding a metal substrate with a thickness of 0.05 mm or more and 0.2 mm or less to a first-stage stamping equipment having a first-stage forming die;
a first-stage forming process of utilizing the first-stage stamping equipment to perform first-stage stamping pre-forming on the metal substrate to form a pre-formed metal bipolar plate;
a transfer and electric treatment process of controlling a transfer and electric treatment device to move the pre-formed metal bipolar plate to an electric treatment station on the transfer and electric treatment device for electric treatment, and taking out an electrically-treated metal bipolar plate after the electric treatment is finished, wherein a clamping area for the electric treatment is greater than 500 mm²;
a second-stage forming process of utilizing a second-stage stamping equipment to perform second-stage stamping forming on the electrically-treated metal bipolar plate to obtain a completely-formed metal bipolar plate; and
an unloading process of removing the completely-formed metal bipolar plate from the second-stage stamping equipment;
the transfer and electric treatment device includes an electric treatment carrying platform and a transfer platform above the electric treatment carrying platform; the electric treatment carrying platform includes electrode units disposed to be opposite; the electrode unit includes an electrode fixture that can be manipulatively pressed to be closed and opened; the transfer platform is mounted above the electric treatment carrying platform through a vertically movable bracket; the transfer platform is disposed on the vertically movable bracket to be manipulated to move up and down; the transfer platform includes a rectangular frame, and a suction cup assembly that is disposed on the rectangular frame to be manipulated to move in a horizontal direction; the suction cup assembly is used to suck up the metal substrate or the metal polar plate; the suction cup assembly has a first horizontal position and a second horizontal position in the horizontal direction relative to the rectangular frame; the transfer platform has a first height position and a second height position above the first height position on the vertically movable bracket.

2. The method for preparing a metal bipolar plate of a fuel cell according to claim 1, wherein at least one intermediate-stage forming process is further included between the first-stage forming process and the second-stage forming process to perform stamping and forming on the metal bipolar plate, and the electric treatment process is disposed between every two adjacent forming processes.

3. The method for preparing a metal bipolar plate of a fuel cell according to claim 1, wherein during the transfer and electric treatment process, the suction cup assembly is controlled to suck up the pre-formed metal bipolar plate at the second horizontal position and the second height position, then the electrode fixture is opened, and the suction cup assembly is controlled to descend to the first height position and move from the second horizontal position to the first horizontal position. The pre-formed metal bipolar plate is then fed between the electrode fixture, and the suction cup assembly is controlled to release the pre-formed metal bipolar plate and the electrode fixture is controlled to press the pre-formed metal plate for electric treatment. Finally, the electrode fixture is opened to further control the suction cup assembly to suck up the electrically treated metal bipolar plate again to move from the first horizontal position to the second horizontal position, and then the electrically treated metal bipolar plate is moved upward to the second height position.

4. The method for preparing a metal bipolar plate of a fuel cell according to claim 1, wherein during the feeding process, a robotic arm is controlled to feed the metal substrate to the first-stage stamping equipment, and after the first-stage forming process is completed, the pre-formed metal bipolar plate is removed from the first-stage stamping equipment; after the transfer and electric treatment process is completed, the electrically treated metal bipolar plate is transferred to the second-stage stamping equipment by the robotic arm; and during the unloading process, the robotic arm is controlled to remove the completely-formed metal bipolar plate from the second-stage stamping equipment.

5. The method for preparing a metal bipolar plate of a fuel cell according to claim 1, further comprising an electric treatment parameter acquisition process to acquire electric treatment parameters of the pre-formed metal bipolar plate when the maximum temperature reaches 500-1200 °C at the end of the electric treatment time and the power is cut off; the electric treatment time is 0.5-10 seconds.

6. The method for preparing a metal bipolar plate of a fuel cell according to claim 1, wherein the temperature of the pre-formed metal bipolar plate under electric treatment conditions is monitored by an infrared thermal imager.

7. The method for preparing a metal bipolar plate of a fuel cell according to claim 1, wherein the electric treatment uses constant voltage direct current or pulse direct current; wherein the output voltage amplitude is 0 -300 V, the duty cycle is 0-100%, and the frequency is 100-4000 Hz.

8. The method for preparing a metal bipolar plate of a fuel cell according to claim 1, wherein the electric treatment carrying platform is provided with a first electrically driven guide rail, the electrode fixture includes a lower electrode with both ends fixedly connected to the first electrically driven guide rail and an upper electrode with both ends movably connected to the first electrically driven guide rail, and the first electrically driven guide rail is capable of driving the upper electrode to move up and down to open and close the electrode fixture;
the transfer platform includes an electrically driven telescopic guide rail disposed at a lower side of the rectangular frame; the suction cup assembly is connected between two electrically driven telescopic guide rails and is driven to switch between the first horizontal position and the second horizontal position;
the vertically movable bracket includes two second electrically driven guide rails vertically disposed on the electric treatment carrying platform, and the rectangular frame vertically connects the two second electrically driven guide rails and is driven to switch between the first height position and the second height position.

9. A metal bipolar plate multi-step forming production line for implementing the method for preparing a metal bipolar plate of a fuel cell according to claim 1, comprising: a feeding device, a first-stage stamping equipment, a transfer and electric treatment device, a second-stage stamping equipment and an unloading device; wherein
the feeding device is used to feed a metal substrate to a first-stage stamping equipment having a first-stage forming die;
the first-stage stamping equipment is used to perform first-stage stamping pre-forming on the metal substrate to form a pre-formed metal bipolar plate;
the transfer and electric treatment device is used to move the pre-formed metal bipolar plate to an electric treatment station on the transfer and electric treatment device for electric treatment, and to take out an electrically-treated metal bipolar plate after the electric treatment is finished;
the second-stage stamping equipment is used to perform second-stage stamping forming on the electrically-treated metal bipolar plate to obtain a completely-formed metal bipolar plate;
the unloading device is used to remove the completely-formed metal bipolar plate from the second-stage stamping equipment.
